(19) United States
(12) Patent Application Publication
(10) Pub. No.: US 2025/0233898 A1
(43) Pub. Date: Jul. 17, 2025

(54) Virtual User Equipment Set

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 18/253,506

(22) PCT Filed: Nov. 12, 2021
(86) PCT No.: PCT/US2021/059144

§ 371 Date: May 18, 2023

Related U.S. Application Data
(60) Provisional application No. 63/120,926, filed on Dec. 3, 2020.

(51) Int. Cl. H04L 65/1066; H04W 4/08; H04W 12/0431; H04W 12/75; H04W 60/00

(52) U.S. Cl. CPC H04L 65/1066; H04W 4/08; H04W 12/0431; H04W 12/75; H04W 60/005

(57) ABSTRACT

This document describes methods, devices, systems, and means for managing a virtual user equipment, UE, set by a network entity, the network entity registering multiple user equipment to the virtual UE set, generating a virtual-UE-set session context, and sending a virtual-UE-set context notification to a base station, directing the base station to transmit the virtual-UE-set session context to each of the multiple user equipment in the virtual UE set. The network entity determines that a first user equipment in the virtual UE set is in-focus for aa first instance of an application, applies a first set of capabilities associated with the first UE to a session for the first instance of the application, and based on the relaying, relays data between the first instance of the application and an application server based on the first set of capabilities.

### BACKGROUND

The evolution of wireless communication to fifth generation (5G), sixth generation (6G), or subsequent generations of standards and technologies provides higher data rates and greater capacity, with improved reliability and lower latency, which enhances mobile broadband services. A single user may have multiple devices that connect over these wireless technologies. The user may use the same application or service on each of these multiple devices, with each device offering varying technical capabilities.

To provide a seamless transition of user experience when switching between devices, an application (and its associated web service) track session context information to allow the user to continue using the application after switching devices. The burden of tracking this session context information at the application protocol layer falls to the developer of the application. However, there is an opportunity to improve the performance when switching between devices and to reduce the burden on application developers of managing application continuity during device switches by the user.

### SUMMARY

This summary is provided to introduce concepts of a virtual user equipment set. The concepts are further described below in the Detailed Description. This summary is not intended to identify essential features of the claimed subject matter, nor is it intended for use in determining the scope of the claimed subject matter.

In aspects, methods, devices, systems, and means for managing a virtual user equipment (UE) set by a network entity describe the network entity registering multiple user equipment to the virtual UE set, generating a virtual-UE-set session context, sending a virtual-UE-set context notification to a base station, and directing the base station to transmit the virtual-UE-set session context to each of the multiple user equipment in the virtual UE set. The network entity determines that a first user equipment in the virtual UE set is in-focus for a first instance of an application, applies a first set of capabilities associated with the first UE to a session for the first instance of the application, relays data between the first instance of the application and an application server based on the first set of capabilities, and based on the relaying, updates the virtual-UE-set session context to produce a current virtual-UE-set context.

### BRIEF DESCRIPTION OF THE DRAWINGS

Aspects of a virtual user equipment set are described with reference to the following drawings. The same numbers are used throughout the drawings to reference like features and components:

FIG. 1 illustrates an example wireless network system in which various aspects of a virtual user equipment set can be implemented.

FIG. 2 illustrates an example device diagram that can implement various aspects of a virtual user equipment set.

FIG. 3 illustrates an example block diagram of a wireless network stack model in which various aspects of a virtual user equipment set can be implemented.

FIG. 4 illustrates an air interface resource that extends between a user equipment and a base station and with which various aspects of a virtual user equipment set can be implemented.

FIG. 5 illustrates example data and control transactions between a first, user equipment, a second user equipment, a base station, and a core network in accordance with aspects of a virtual user equipment set.

FIG. 6 illustrates an example method in accordance with aspects of a virtual user equipment set.

### DETAILED DESCRIPTION

Increasingly, users have multiple devices connected using wireless technologies and use applications and services across these devices. Despite the technical complexities involved, users expect application contexts and user experiences to be maintained seamlessly across these multiple devices. The burden of this maintenance typically falls upon the application, its associated Web services, and the application developer.

A core network function in a radio access network (RAN) can register a virtual user equipment (UE) set that includes multiple UEs (each with an individual Subscriber Identity Module (SIM)) that are mutually trusted among themselves (e.g., the multiple UE are all owned by/registered to the same user). The core network function (e.g., an Access and Mobility Function (AMF), a User Plane Function (UPF)) establishes a common virtual-UE-set session context and a common security context for the UEs in the virtual UE set. The base station serving the virtual UE set assigns a common Cell Radio Network Temporary Identifier (C-RNTI) to the UEs in the virtual UE set. An application server maintains a common device session context for its application that can execute on any of the UEs in the virtual UE set. From a network point of view, UEs within this virtual UE set behave like a single UE.

Sharing these common security and/or session contexts and identifiers among the UEs in the virtual UE set reduces latency when switching focus between different instances of an application on UEs in the virtual UE set. Supporting common security and/or session contexts at lower protocol layers of the network protocol stack provides common mechanisms to support applications, which reduces application development efforts. UEs in the virtual UE set can share downlink traffic allocations, which increase the spectral efficiency of the RAN when multiple devices in the virtual UE set are running different instances of the same application.

While features and concepts of the described devices, systems, and methods for a virtual user equipment set can be implemented in any number of different environments, systems, devices, and/or various configurations, aspects of a virtual user equipment set are described in the context of the following example devices, systems, and configurations.

### Example Environment

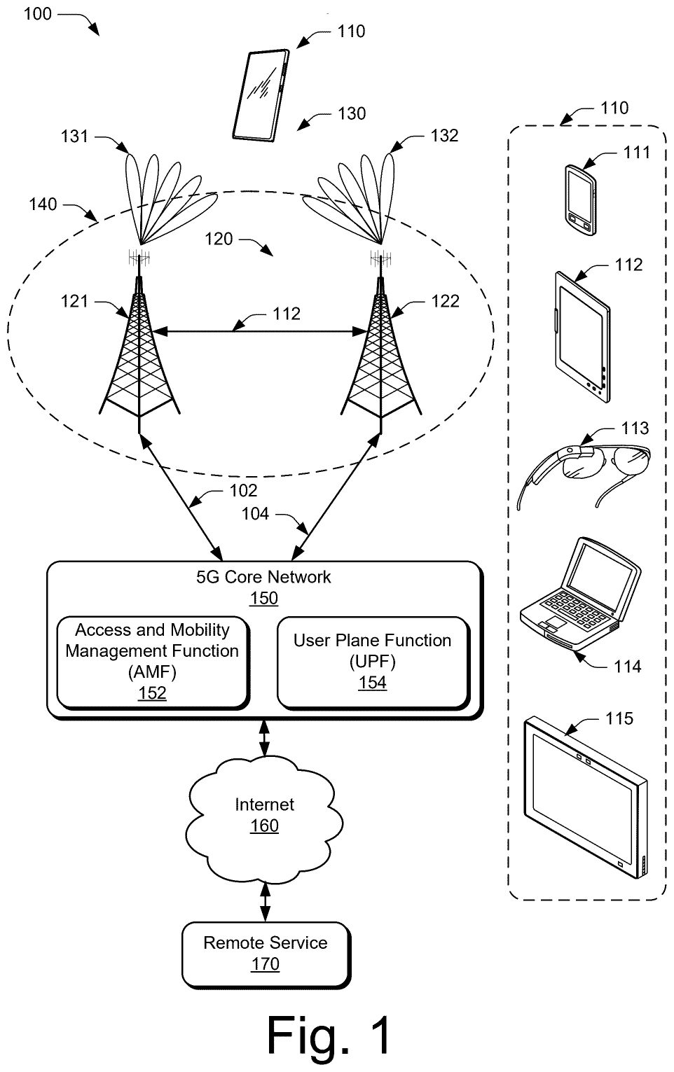

FIG. 1 illustrates an example environment 100 in which various aspects of a virtual user equipment set can be implemented. The example environment 100 includes a user equipment 110 (UE 110) that communicates with one or more base stations 120 (illustrated as base stations 121 and 122), through one or more wireless communication links 130 (wireless link 130), illustrated as wireless links 131 and 132. Although the user equipment 110 in this example is illustrated as a smartphone, the user equipment 110 may be implemented as any suitable computing or electronic device, such as a smartphone 111, a tablet computer 112, smart glasses 113, a laptop computer 114, a smart television 115, a mobile communication device, a modem, a cellular phone, a gaming device, a navigation device, a media device, a desktop computer, a smart appliance, a smart watch, or a vehicle-based communication system. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, a 6G node B, or the like) may be implemented in a macrocell, microcell, small cell, picocell, distributed base station, and the like, or any combination or future evolution thereof.

The base stations 120 communicate with the user equipment 110 via the wireless links 131 and 132, which may be implemented as any suitable type of wireless link. In this example, the wireless links 131 and 132 are beamformed; however, a base station 120 may alternatively or additionally implement omnidirectional or other spatial geometries. The wireless links 131 and 132 can include a downlink of data and control information communicated from the base stations 120 to the user equipment 110, an uplink of other data and control information communicated from the user equipment 110 to the base stations 120, or both. The wireless links 130 may include one or more wireless links or bearers implemented using any suitable communication protocol or standard, or combination of communication protocols or standards such as 3rd Generation Partnership Project Long-Term Evolution (3GPP LTE), Fifth Generation New Radio (5G NR), 6G, and so forth. Multiple wireless links 130 may be aggregated in a carrier aggregation to provide a higher data rate for the user equipment 110. Multiple wireless links 130 from multiple base stations 120 may be configured for Coordinated Multipoint (COMP) communication with the user equipment 110. Additionally, multiple wireless links 130 may be configured for single-radio access technology (RAT) (single-RAT) dual connectivity (single-RAT-DC) or multi-RAT dual connectivity (MR-DC).

The base stations 120 collectively form a Radio Access Network 140 (RAN, Evolved Universal Terrestrial Radio Access Network, E-UTRAN, 5G NR RAN or NR RAN). The base stations 121 and 122 in the RAN 140 are connected to a core network 150, such as a Fifth Generation Core (5GC) or 6G core network. The base stations 121 and 122 connect, at 102 and 104 respectively, to the core network 150 via an NG2 interface (or analogous 6G interface) for control-plane signaling and via an NG3 interface (or analogous 6G interface) for user-plane data communications. In addition to connections to core networks, base stations 120 may communicate with each other via an Xn Application Protocol (XnAP), at 112, to exchange user-plane and control-plane data. The user equipment 110 may also connect, via the core network 150, to public networks, such as the Internet 160 to interact with a remote service 170.

The core network 150 includes an Access and Mobility Management Function 152 (AMF 152), which provides control-plane functions, such as registration and authentication of multiple UEs 110, authorization, and mobility management in the 5G NR network. The AMF 152 communicates with the base stations 120 in the RANs 140 and also communicates with multiple UEs 110, using one or more of the base stations 120. The core network 150 includes a User Plane Function 154 (UPF 154) that relays user-plane data between the Internet 160 and the UE s 110.

### Example Devices

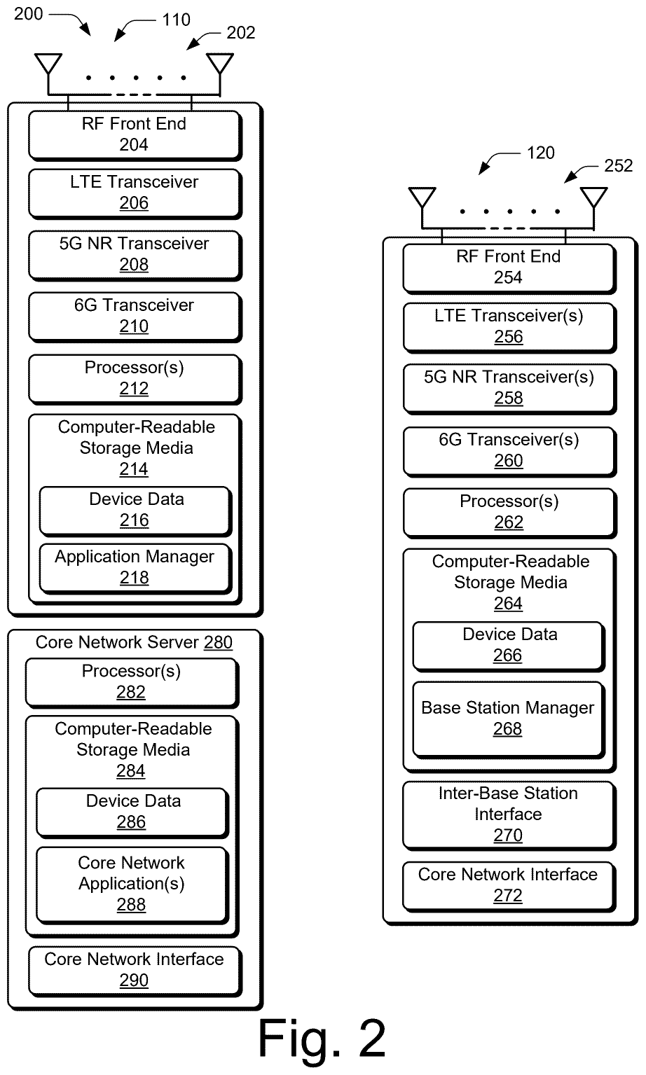

FIG. 2 illustrates an example device diagram 200 of the user equipment 110, the base stations 120, and a core network server 280. The user equipment 110 and the base stations 120 may include additional functions and interfaces that are omitted from FIG. 2 for the sake of clarity. The user equipment 110 includes antennas 202, a radio frequency front end 204 (RF front end 204), an LTE transceiver 206, a 5G NR transceiver 208, and a 6G transceiver 210 for communicating with base stations 120 in the RAN 140. The RF front end 204 of the user equipment 110 can couple or connect the LTE transceiver 206, the 5G NR transceiver 208, and the 6G transceiver 210 to the antennas 202 to facilitate various types of wireless communication. The antennas 202 of the user equipment 110 may include an array of multiple antennas that are configured similarly to or differently from each other. The antennas 202 and the RF front end 204 can be tuned to, and/or be tunable to, one or more frequency bands defined by the 3GPP LTE, 5G NR, and 6G communication standards and implemented by the LTE transceiver 206, the 5G NR transceiver 208, and/or the 6G transceiver 210. Additionally, the antennas 202, the RF front end 204, the LTE transceiver 206, the 5G NR transceiver 208, and/or the 6G transceiver 210 may be configured to support beamforming for the transmission and reception of communications with the base stations 120. By way of example and not limitation, the antennas 202 and the RF front end 204 can be implemented for operation in sub-gigahertz bands, sub-6 GHz bands, and/or above 6 GHz bands that are defined by the 3GPP LTE, 5G NR, and 6G communication standards.

The user equipment 110 also includes processor(s) 212 and computer-readable storage media 214 (CRM 214). The processor 212 may be a single core processor or a multiple core processor composed of a variety of materials, such as silicon, polysilicon, high-K dielectric, copper, and so on. The computer-readable storage media described herein excludes propagating signals. CRM 214 may include any suitable memory or storage device such as random-access memory (RAM), static RAM (SRAM), dynamic RAM (DRAM), non-volatile RAM (NVRAM), read-only memory (ROM), or Flash memory useable to store device data 216 of the user equipment 110. The device data 216 includes user data, multimedia data, beamforming codebooks, applications, and/or an operating system of the user equipment 110, which are executable by processor(s) 212 to enable user-plane communication, control-plane signaling, and user interaction with the user equipment 110.

In some implementations, the CRM 214 may also include an application manager 218. The application manager 218 can communicate with the antennas 202, the RF front end 204, the LTE transceiver 206, the 5G NR transceiver 208, and/or the 6G transceiver 210 to monitor the quality of the wireless communication links 130. Based on this monitoring and scheduling assistance information, the application manager 218 can determine to adjust application-related parameters of applications running on the UE 110.

The device diagram for the base stations 120, shown in FIG. 2, includes a single network node (e.g., a gNode B). The functionality of the base stations 120 may be distributed across multiple network nodes or devices and may be distributed in any fashion suitable to perform the functions described herein. The nomenclature for this split base station functionality varies and includes terms such Central Unit (CU), Distributed Unit (DU), Baseband Unit (BBU), Remote Radio Head (RRH), and/or Remote Radio Unit (RRU). The base stations 120 include antennas 252, a radio frequency front end 254 (RF front end 254), one or more LTE transceivers 256, one or more 5G NR transceivers 258, and/or one or more 6G transceivers 260 for communicating with the UE 110. The RF front end 254 of the base stations 120 can couple or connect the LTE transceivers 256, the 5G NR transceivers 258, and/or the 6G transceivers 260 to the antennas 252 to facilitate various types of wireless communication. The antennas 252 of the base stations 120 may include an array of multiple antennas that are configured similarly to or differently from each other. The antennas 252 and the RF front end 254 can be tuned to, and/or be tunable to, one or more frequency band defined by the 3GPP LTE, 5G NR, and 6G communication standards, and implemented by the LTE transceivers 256, one or more 5G NR transceivers 258, and/or one or more 6G transceivers 260. Additionally, the antennas 252, the RF front end 254, the LTE transceivers 256, one or more 5G NR transceivers 258, and/or one or more 6G transceivers 260 may be configured to support beamforming, such as Massive-MIMO, for the transmission and reception of communications with the UE 110.

The base stations 120 also include processor(s) 262 and computer-readable storage media 264 (CRM 264). The processor 262 may be a single core processor or a multiple core processor composed of a variety of materials, such as silicon, polysilicon, high-K dielectric, copper, and so on. CRM 264 may include any suitable memory or storage device such as random-access memory (RAM), static RAM (SRAM), dynamic RAM (DRAM), non-volatile RAM (NVRAM), read-only memory (ROM), or Flash memory useable to store device data 266 of the base stations 120. The device data 266 includes network scheduling data, radio resource management data, beamforming codebooks, applications, and/or an operating system of the base stations 120, which are executable by processor(s) 262 to enable communication with the user equipment 110.

CRM 264 also includes a base station manager 268. Alternately or additionally, the base station manager 268 may be implemented in whole or part as hardware logic or circuitry integrated with or separate from other components of the base stations 120. In at least some aspects, the base station manager 268 configures the LTE transceivers 256, the 5G NR transceivers 258, and the 6G transceiver(s) 260 for communication with the user equipment 110, as well as communication with a core network, such as the core network 150, and routing user-plane and control-plane data for joint communication. Additionally, the base station manager 268 may allocate air interface resources and schedule communications for the UE 110.

The base stations 120 include an inter-base station interface 270, such as an Xn and/or X2 interface, which the base station manager 268 configures to exchange user-plane and control-plane data between other base stations 120, to manage the communication of the base stations 120 with the user equipment 110. The base stations 120 include a core network interface 272 that the base station manager 268 configures to exchange user-plane and control-plane data with core network functions and/or entities.

The core network server 280 may provide all or part of a function, entity, service, and/or gateway in the core network 150. Each function, entity, service, and/or gateway in the core network 150 may be provided as a service in the core network 150, distributed across multiple servers, or embodied on a dedicated server. For example, the core network server 280 may provide all or a portion of the services or functions of a User Plane Function (UPF), a Session Management Function (SMF), or an Access and Mobility Function (AMF). The core network server 280 is illustrated as being embodied on a single server that includes processor(s) 282 and computer-readable storage media 284 (CRM 284). The processor 282 may be a single core processor or a multiple core processor composed of a variety of materials, such as silicon, polysilicon, high-K dielectric, copper, and so on. CRM 284 may include any suitable memory or storage device such as random-access memory (RAM), static RAM (SRAM), dynamic RAM (DRAM), non-volatile RAM (NVRAM), read-only memory (ROM), hard disk drives, or Flash memory useful to store device data 286 of the core network server 280. The device data 286 includes data to support a core network function or entity, and/or an operating system of the core network server 280, which are executable by processor(s) 282.

CRM 284 also includes one or more core network applications 288, which, in one implementation, is embodied on CRM 284 (as shown). The one or more core network applications 288 may implement the functionality of a User Plane Function (UPF), a Session Management Function (SMF), or an Access and Mobility Function 152 (AMF 152). Alternately or additionally, the one or more core network applications 288 may be implemented in whole or part as hardware logic or circuitry integrated with or separate from other components of the core network server 280. The core network server 280 also includes a core network interface 290 for communication of user-plane and control-plane data with the other functions or entities in the core network 150 or base stations 120 using any of the network interfaces described herein.

### User Plane and Control Plane Signaling

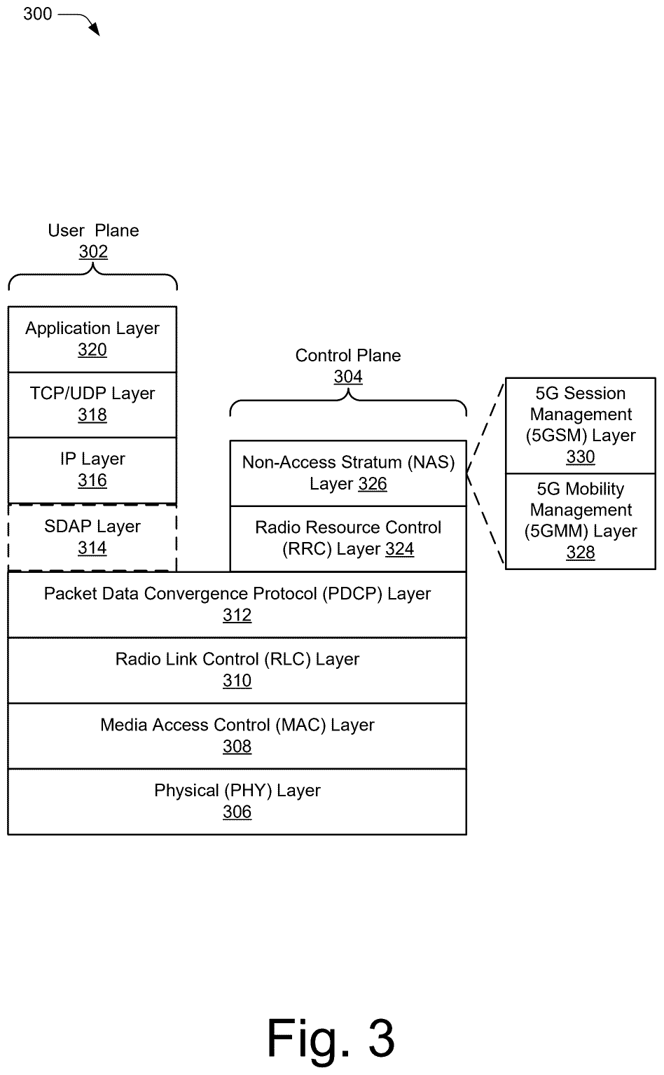

FIG. 3 illustrates an example block diagram 300 of a wireless network stack model 300 (stack 300, network stack 300). The network stack 300 characterizes a communication system for the example environment 100, in which various aspects of a virtual user equipment set can be implemented. The network stack 300 includes a user plane 302 and a control plane 304. Upper protocol layers of the user plane 302 and the control plane 304 share common lower protocol layers in the network stack 300. Wireless devices, such as the UE 110 or the base station 120, implement each protocol layer as an entity for communication with another device using the protocols defined for the layer. For example, a UE 110 uses a Packet Data Convergence Protocol (PDCP) entity to communicate to a peer PDCP entity in a base station 120 using the PDCP.

The shared lower protocol layers include a physical (PHY) layer 306, a Media Access Control (MAC) layer 308, a Radio Link Control (RLC) layer 310, and a PDCP layer 312. The PHY layer 306 provides hardware specifications for devices that communicate with each other. As such, the PHY layer 306 establishes how devices connect to each other, assists in managing how communication resources are shared among devices, and the like.

The MAC layer 308 specifies how data is transferred between devices. Generally, the MAC layer 308 provides a way in which data packets being transmitted are encoded and decoded into bits as part of a transmission protocol.

The RLC layer 310 provides data transfer services to higher protocol layers in the network stack 300. Generally, the RLC layer 310 provides error correction, packet segmentation and reassembly, and management of data transfers in various modes, such as acknowledged, unacknowledged, or transparent modes.

The PDCP layer 312 provides data transfer services to higher protocol layers in the network stack 300. Generally, the PDCP layer 312 provides transfer of user plane 302 and control plane 304 data, header compression, ciphering, and integrity protection.

Above the PDCP layer 312, the stack splits into the user-plane 302 and the control-plane 304. Protocol layers of the user plane 302 include an optional Service Data Adaptation Protocol (SDAP) layer 314, an Internet Protocol (IP) layer 316, a Transmission Control Protocol/User Datagram Protocol (TCP/UDP) layer 318, and an application layer 320, which transfers data using the wireless link 106. The optional SDAP layer 314 is present in 5G NR networks. The SDAP layer 314 maps a Quality of Service (QOS) flow for each data radio bearer and marks QoS flow identifiers in uplink and downlink data packets for each packet data session. The IP layer 316 specifies how the data from the application layer 320 is transferred to a destination node. The TCP/UDP layer 318 verifies that data packets intended to be transferred to the destination node reached the destination node, using either TCP or UDP for data transfers by the application layer 320. In some implementations, the user plane 302 may also include a data services layer (not shown) that provides data transport services to transport application data, such as IP packets including web browsing content, video content, image content, audio content, or social media content.

The control plane 304 includes a Radio Resource Control (RRC) layer 324 and a Non-Access Stratum (NAS) layer 326. The RRC layer 324 establishes and releases connections and radio bearers, broadcasts system information, or performs power control. The RRC layer 324 also controls a resource control state of the UE 110 and causes the UE 110 to perform operations according to the resource control state. Example resource control states include a connected state (e.g., an RRC connected state) or a disconnected state, such as an inactive state (e.g., an RRC inactive state) or an idle state (e.g., an RRC idle state). In general, if the UE 110 is in the connected state, the connection with the base station 120 is active. In the inactive state, the connection with the base station 120 is suspended. If the UE 110 is in the idle state, the connection with the base station 120 is released. Generally, the RRC layer 324 supports 3GPP access but does not support non-3GPP access (e.g., WLAN communications).

The NAS layer 326 provides support for mobility management (e.g., using a Fifth-Generation Mobility Management (5GMM) layer 328) and packet data bearer contexts (e.g., using a Fifth-Generation Session Management (5GSM) layer 330) between the UE 110 and entities or functions in the core network, such as the Access and Mobility Management Function 152 (AMF 152) of the 5GC 150 or the like. The NAS layer 326 supports both 3GPP access and non-3GPP access.

In the UE 110, each protocol layer in both the user plane 302 and the control plane 304 of the network stack 300 interacts with a corresponding peer layer or entity in the base station 120, a core network entity or function, and/or a remote service, to support user applications and control operation of the UE 110 in the RAN 140.

### Air Interface Resources

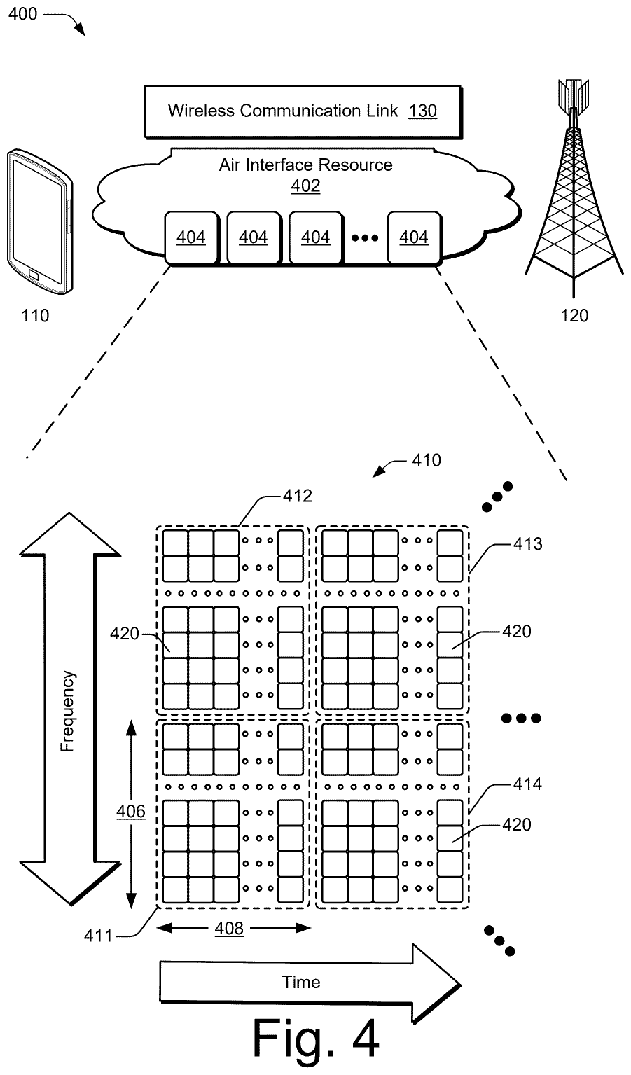

FIG. 4 illustrates an air interface resource that extends between a user equipment and a base station and with which various aspects of a virtual user equipment set can be implemented. The air interface resource 402 can be divided into resource units 404, each of which occupies some intersection of frequency spectrum and elapsed time. A portion of the air interface resource 402 is illustrated graphically in a grid or matrix having multiple resource blocks 410, including example resource blocks 411, 412, 413, 414. An example of a resource unit 404 therefore includes at least one resource block 410. As shown, time is depicted along the horizontal dimension as the abscissa axis, and frequency is depicted along the vertical dimension as the ordinate axis. The air interface resource 402, as defined by a given communication protocol or standard, may span any suitable specified frequency range, and/or may be divided into intervals of any specified duration. Increments of time can correspond to, for example, milliseconds (ms). Increments of frequency can correspond to, for example, megahertz (MHz).

In example operations generally, the base stations 120 allocate portions (e.g., resource units 404) of the air interface resource 402 for uplink and downlink communications. Each resource block 410 of network access resources may be allocated to support respective wireless communication links 130 of multiple user equipment 110. In the lower left corner of the grid, the resource block 411 may span, as defined by a given communication protocol, a specified frequency range 406 and include multiple subcarriers or frequency sub-bands. The resource block 411 may include any suitable number of subcarriers (e.g., 12) that each correspond to a respective portion (e.g., 15 kHz) of the specified frequency range 406 (e.g., 180 kHz). The resource block 411 may also span, as defined by the given communication protocol, a specified time interval 408 or time slot (e.g., lasting approximately one-half millisecond or 7 orthogonal frequency-division multiplexing (OFDM) symbols). The time interval 408 includes subintervals that may each correspond to a symbol, such as an OFDM symbol. As shown in FIG. 4, each resource block 410 may include multiple resource elements 420 (REs) that correspond to, or are defined by, a subcarrier of the frequency range 406 and a subinterval (or symbol) of the time interval 408. Alternatively, a given resource element 420 may span more than one frequency subcarrier or symbol. Thus, a resource unit 404 may include at least one resource block 410, at least one resource element 420, and so forth.

### Virtual User Equipment Set

A user may have multiple UE-devices (e.g., a smartphone, a tablet computer, a smartwatch, smart glasses, a smart television, etc.). As the user switches between using different UE-devices, the user expects seamless user experience contexts to be maintained across the multiple devices, within the varying capabilities of the different devices.

In one aspect, an application, with which the user is actively engaging, is focused on a particular UE 110 (e.g., that particular UE 110 is a focused-UE for the application) in the virtual UE set. For that application, other UEs 110 in the virtual UE set are defocused (e.g., the other UEs are defocused-UEs). Different user applications may have different focused-UEs (and defocused-UEs) within the virtual UE set. For example, at home the user is playing a gaming application on the smart television 115; thus, the smart television 115 is the focused-UE for a first instance of the gaming application. The user may also be engaged in a voice call using the smartphone 111. For the voice calling application, the smartphone 111 is the focused-UE.

The UE(s) focused on an application can change over time, and a particular UE can be the focused-UE for multiple applications. Continuing with the example, the user leaves home and wants to continue playing the gaming application. When the user starts a second instance of the gaming application on the smartphone 111, the smartphone 111 becomes the focused-UE for the gaming application while continuing to be the focused-UE for the voice calling application.

In another aspect, multiple UEs can be focused-UEs for an application. For example, the user is streaming media using a streaming application on the smart television 115 (the smart television 115 being the focused-UE for the streaming application). The user chooses to also stream the media simultaneously on the tablet computer 112. Starting the streaming application on the tablet computer 112 causes the tablet computer 112 to transition from being defocused to focused for the streaming application. The smart television 115 remains focused for the streaming application as well.

To establish as virtual UE set, a core network function (e.g., an Access and Mobility Function 152 (AMF 152)) in the core network 150 registers each UE 110 (with an individual Subscriber Identity Module (SIM)) as a member of the virtual UE set. Throughout this document, the term Subscriber Identity Module (SIM) may be understood to include an embedded-SIM (eSIM) or other hardware and/or software having functionality of a SIM. The UEs included in the virtual UE set are mutually trusted among themselves (e.g., the multiple UEs are all owned by/registered to the same user). The core network function (e.g., the AMF 152) establishes a common security context (e.g., a security context including the encryption and authentication techniques described in 3GPP TS 33.501) for the UEs in the virtual UE set. After a virtual UE set is established, a user can request the AMF 152 add additional UEs to and/or remove UEs from the virtual UE set.

UEs within a virtual UE set share the same virtual-UE-set session and security contexts at the AMF 152. The virtual-UE context includes session context information that is common to all the UEs in the virtual UE set. The virtual-UE-set session context can include a Globally Unique Temporary Identifier (GUTI), network slice(s), a Protocol Data Unit (PDU) session, an IP address, a QoS flow, a PHY layer identity and/or a MAC layer identity. For example, the AMF 152 assigns the same Globally Unique Temporary Identifier (GUTI) to UEs within the virtual UE set.

UEs within the virtual UE set share the same security keys and security context. For example, the user signs a (secure digital) agreement to share the same security key among the trusted UEs in the virtual UE set. Alternatively, each application can manage end-to-end security for the application's user-plane data including the application creating application-specific keys for end-to-end security (e.g., end-to-end encryption) between the application on the UEs in the virtual UE set and the application server.

Each UE 110 in the virtual UE set can have different UE capabilities. The UE capability of each UE 110 in the virtual UE set is associated with the SIM in each respective UE that is registered to the network.

A virtual UE capability for the virtual UE set is based on the UE(s) in the virtual UE set that are in-focus. The network tracks the activity of the UEs in the virtual UE set to determine changes to the virtual UE capability to be applied to the virtual UE set. The virtual UE capability of the virtual UE set can change based on the RRC connection state (idle, inactive, connected) of the UEs in the virtual UE set, as monitored by the network. In one alternative, in the event that there are multiple in-focus UEs for a single application, then the minimum UE capability defines the capability of the virtual UE set. In another alternative, if multiple UEs in the virtual UE set are interacting with the same application server, the network and/or application server maintains the UE capability of each respective UE for the application instance on that UE.

When different UEs have different minimum UE capabilities along the same dimension, the minimum virtual UE capabilities for the virtual UE set can be composed of the least common denominator for each capability across the multiple UEs. For example, the minimum virtual UE capabilities can include a minimum downlink throughput and a minimum uplink throughput even when the two minimum throughput values are associated with different in-focus UEs of the virtual UE set.

In further aspects, the UEs in the virtual UE set share the same network slices. For example, a network slice associated with an application server is available to whichever UE in the virtual UE set is focused on that application. The UEs in the virtual UE set share the same Protocol Data Unit (PDU) session and/or Internet Protocol (IP) address. Regardless of which UE in the virtual UE set is focused on an application or when focus switches from one UE to another UE, the application server communicates to the focused-UE using the same, single PDU session and/or IP address. For applications that use a Quality of Service (QOS) flow, the UEs in the virtual UE set share that QoS flow.

In another aspect, UEs 110 within a virtual UE set share the same security context with the base station 121. The security context for the virtual UE set can be based on a virtual-UE-set master key. For example, the virtual-UE-set master key can be used for key derivations for the virtual-UE-set in a manner similar to the key derivations for a single UE based on the UE security key, K. UEs within the virtual UE set can share the same PHY and/or MAC identities, such as a C-RNTI. For example, UE 111 is in the same virtual UE set as UE 112, and UE 111 already has a C-RNTI. When UE 112 is performing a Random Access Channel (RACH) procedure, the UE 112 can use the same C-RNTI as UE 111 to perform a contention-free RACH procedure, and the base station 120 will then associate the UE 112 to the same C-RNTI as UE 111. The UE 112 can either receive the same C-RNTI over a sideband communication (e.g., a peer-to-peer communication that does not involve the core network 150) from the UE 111 or from the base station 120 during the RACH procedure. By using the same C-RNTI, the UE 112 can use a contention-free RACH procedure that reduces the latency of connecting to the base station 120.

In a further aspect, multiple UEs in the same virtual UE set can share downlink (DL) resource allocations. For example, the UEs can share DL resources allocated to DL streaming content from the same streaming application server. The DL content can be broadcast or multicast using Evolved Multimedia Broadcast Multicast Services (eMBMS). An individual UE in the virtual UE set can request missing packets of the DL content stream using Dynamic Adaptive Streaming over HyperText Transfer Protocol (DASH, MPEG-DASH).

Downlink content (data) for the multiple UEs can be addressed to the UEs using a shared C-RNTI with the UEs concurrently receiving the DL content data. Each of the UEs independently transmits acknowledgements (ACKs) and negative acknowledgements (NACKs) to the base station 120 using separately allocated uplink (UL) resources. If one of the UEs does not correctly receive a portion of the DL content, upper protocol layers of the network stack 300 handle retransmission of the incorrectly received content for the UE. The application consuming the DL content provides audio and/or visual outputs and/or inputs according to user settings of the application instance on each individual UE.

In one alternative, DL content for the multiple UEs in the virtual UE set can be addressed to the multiple UEs using different C-RNTIs for each user device with the different C-RNTIs pointing to the same DL data and DL resource allocation. Each of the multiple UEs uses its own Physical Uplink Control Channel (PUCCH) that is based on Downlink Control Information (DCI) Control Channel Element (CCE) for ACKs and NACKs.

In another aspect, the base station 120 can send a NAS or RRC message to change the NAS or RRC state of multiple UEs in the virtual UE set. The NAS or RRC message can change the state of the multiple UEs to a same state or different states. For example, the base station 120 transmits one RRC message to change the RRC state of the UE 111 from a connected state to an idle state and simultaneously changes the RRC state of the UE 112 from the idle state to the connected state. In another example, the base station 120 transmits one RRC message to change the RRC state of the UE 111 and the UE 112 from a connected state to an idle state.

The virtual UE set has a NAS and/or RRC state that depends on the state of each UE in the virtual UE set. For example, the virtual UE set is in an active state as long as at least one of the UEs in the virtual UE set is in the connected state. In another example, the virtual UE set is in the idle mode only if all the UEs in the virtual UE set are in the idle state.

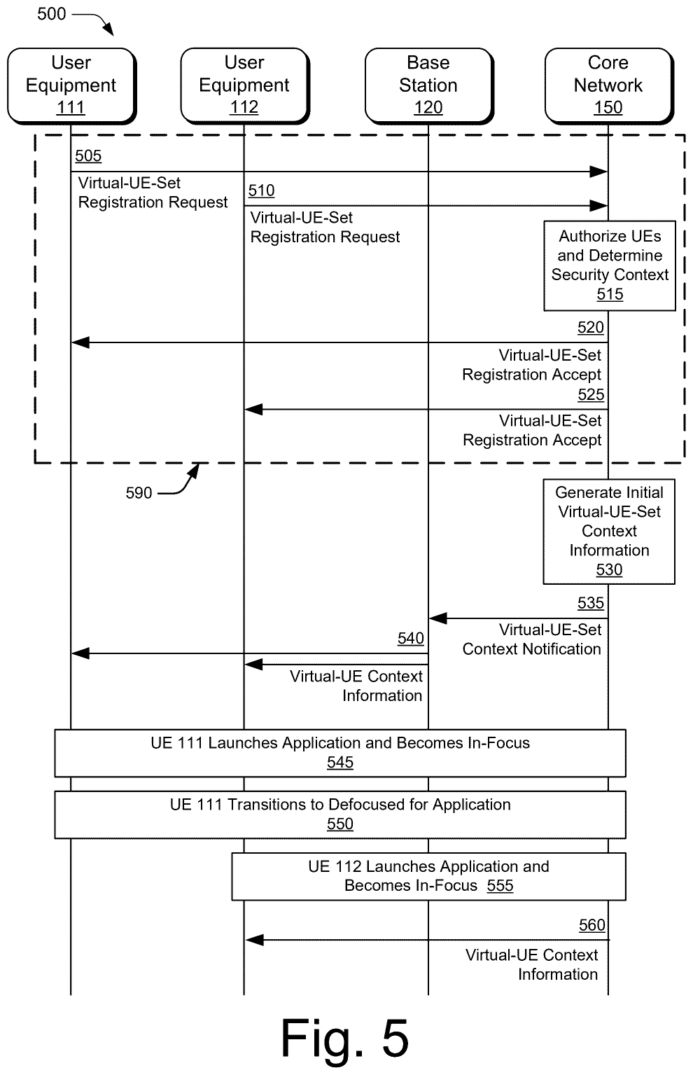

FIG. 5 illustrates example data and control transactions between the UE 111, the UE 112, the base station 120, and the core network 150 in accordance with aspects of a virtual user equipment set. Although not illustrated for the sake of illustration clarity, various acknowledgements for messages illustrated in FIG. 5 may be implemented to ensure reliable operations of a virtual user equipment set.

At 505, the UE 111 sends a virtual-UE-set registration request for inclusion in a virtual UE set. At 510, the UE 112 sends a virtual-UE-set registration request for inclusion in the virtual UE set. For example, the UE 111 and the UE 112 send registration requests to the AMF 152 in the core network 150 via the same base station 120. The UEs 111 and 112 may be provisioned to the account of the same user. The provisioning process can include the user (owner) of the UEs 111 and 112 authorizing the network operator to permit the UEs to share a common security context to operate as a virtual UE set.

At 515, the core network 150 authorizes the UEs 111 and 112 to operate as a virtual UE set and determines a common security context for the virtual UE set. This may involve various types of authentication of the devices and the user accounts on the devices. For example, the network provisions a common virtual-UE-set master key to the SIM of each UE in the virtual UE set, the user of the UEs can consent to including a UE in a virtual-UE-set using an out-of-band security service, or the like. At 520, the core network sends a virtual-UE-set registration accept message to the UE 111. The virtual-UE-set registration accept message may include an indication of parameters of the common security context of the virtual UE set. At 525, the core network sends a virtual-UE-set registration accept message to the UE 112. The virtual-UE-set registration accept message includes the same (common) security context of the virtual UE set that was sent to UE 111 at 520.

Generally, the steps 505 through 525 correspond to a first instance of a sub-diagram 590 that registers UEs in a virtual UE set. The registration 590 may occur once with the virtual UE set registration being retained in the UEs and core network. Changes to the composition of a virtual UE set may involve deletion of the common security context at the network and from all devices of the virtual UE set and a full repetition of 590 or it may involve only making changes to the existing common security context at each UE and network entity. The virtual UE set registration may be an extension of a provisioning process for provisioning the UEs to the network. The process may occur periodically or whenever a UE is added to or deleted from a user's account with the network provider.

At 530, the core network generates an initial virtual-UE-set session context based on the UEs that are in an active state when the core network provisioned the virtual UE set, at 590. For example, the core network exchanges session context information (not illustrated) with the UE 111 and the UE 112 to create connections to application servers to generate the initial virtual-UE-set session context. In an alternative example, if the UE 111 is the only UE in the virtual UE set that is in-focus for an application, the context information of the UE 111 for that application forms the initial virtual-UE-set session context information.

At 535, the core network sends a virtual-UE-set context notification message to the base station(s) serving the UEs in the virtual UE set. The virtual-UE-set context notification message includes the initial virtual-UE-set session context and directs the base station 120 to use the same session context for the UE 111 and the UE 112. The virtual-UE-set context notification message includes the virtual-UE-set session context information (from 530) and the security context (from 515) for the UEs in the virtual UE set. The virtual-UE-set context notification message is a NAS-layer message. At 540, the base station 120 sends the virtual-UE-set session context information to the UE 111 and the UE 112.

At 545, the UE 111 launches a first instance of an application (connects to an application server) and becomes in-focus for the application. The UE 111 uses the session context information for that application from the virtual-UE-set session context if that session context information already exists, or the session context information for the application is established when the application is launched and the core network adds the new session context information for the application to the virtual-UE-set session context. The application can send and receive data between the UE 111 and an application server via the base station 120 and the core network 150 (not illustrated). For example, the user launches a first instance of an application (e.g., a web browser, streaming media player, etc.) on the first UE 111 and interacts with that first application instance to access a remote service 170.

At 550, the UE 111 transitions to being defocused (loses focus) for the first application instance. The network detects this as a session context change in the virtual UE set. For example, the user of the UE 111 switches to another UE in the virtual UE set, such as the UE 112, to continue use the of application on a different device. As another example of losing focus at the first instance, the UE 111 transitions to the RRC idle or inactive mode.

At 555, the UE 112 launches a second instance of the application and becomes in-focus (gains focus) for the application. At 560, based on the UE 112 becoming in-focus, the core network sends the current virtual-UE-set session context to the UE 112 that may include session context information added at 545 for the application. For example, the user launches a second instance of the application on the second UE 112 to access the same remote service 170. The UE 112 uses the virtual-UE-set session context received from the core network to continue use of the application server by the user.

The transition from the UE 111 to the UE 112 being in-focus can be a “soft” or a “hard” transition. For example, a soft transition includes the UE 112 becoming in-focus for the application before the UE 111 transitions to being defocused. The application is running on both the UE 111 and the UE 112 for a period of time providing a smooth transition for the user between the capabilities of the UE 111 and the capabilities of the UE 112 using the lesser of the capabilities of the multiple UEs. In another example, during a hard transition, the UE 111 ceases to be in-focus before the UE 112 becomes in-focus for the application. In this case, temporal glitches may occur before the application session settles to the correct UE capability for the UE 112. For example, the network may continue to operate at a lower data throughput capability of the UE 111 until the application settles and uses a higher data throughput capability of the UE 112.

### Example Method

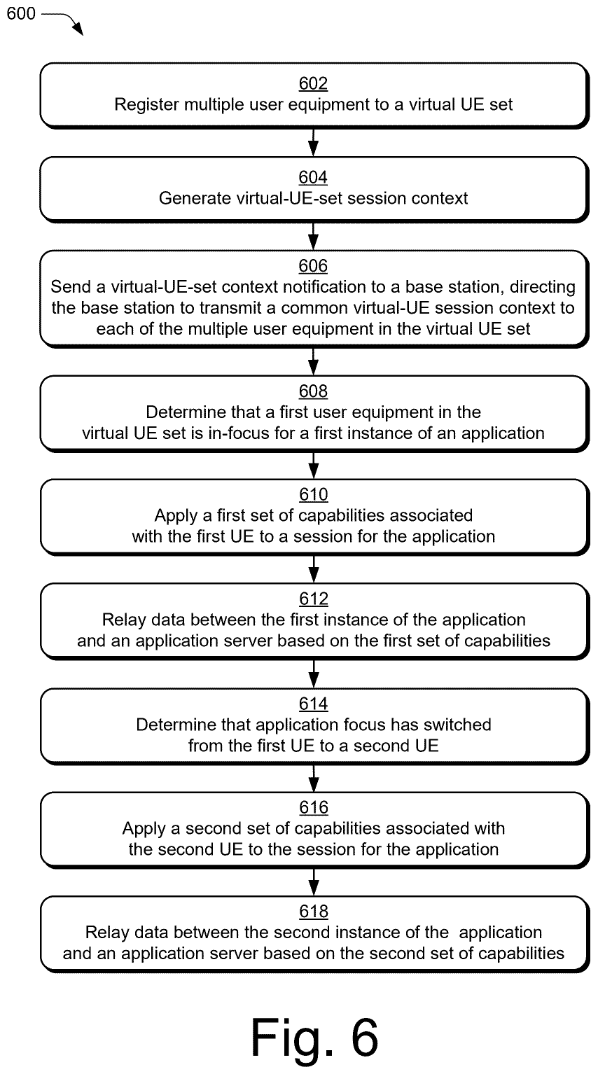

Example method 600 is described with reference to FIG. 6 in accordance with one or more aspects of a virtual user equipment set. FIG. 6 illustrates example method(s) 600 of a virtual user equipment set as generally related to the core network 150.

At block 602, a network entity registers multiple user equipment to a virtual UE set. For example, a network entity in the core network 150 (e.g., the AMF 152) receives 505, 510 a virtual-UE-set registration request message from each of the multiple UEs (e.g., the UE 111, the UE 112), authorizes 515 each of the multiple UEs, and transmits 520, 525 a virtual-UE-set registration accept message to each of the multiple UEs as previously described with reference to FIG. 5 element 590.

At block 604, the network entity generates a virtual-UE-set session context based on the UEs that are in an active state when the core network provisioned the virtual UE set, at block 602. For example, the network entity uses session context information that it previously exchanged with the UE 111 and the UE 112 to create connections to application servers to generate 530 the virtual-UE-set session context. In an alternative example, if the UE 111 is the only UE in the virtual UE set that is in-focus for an application, the session context information for that application is the session context information of the UE 111. The virtual-UE-set session context may include a common C-RNTI, a common IP address, a common PDU session, a common QoS flow, and/or a common network slice.

At block 606, the network entity sends the virtual-UE-set context notification to a base station, directing the base station to transmit a common virtual-UE-set session context to each of the multiple user equipment in the virtual UE set. For example, the network entity sends 535 the common virtual-UE-set session context to a base station (e.g., the base station 120) that the base station forwards to the UEs in the virtual UE set.

At block 608 the network entity determines that a first user equipment in the virtual UE set is in-focus for a first instance of an application. For example, the network entity determines 545 that the first UE is establishing a PDU session with an application server and exchanging application (user-plane) data with the application server for a first instance of the application.

At block 610, the network entity applies a first set of capabilities associated with the first UE to a session for the application. For example, based on the capabilities of the first UE, the network entity sets network parameters to match the capabilities of the first UE, such as any one or more of a maximum downlink throughput, maximum uplink throughput, MIMO layers, a number of carriers that can be aggregated, a maximum bandwidth supported, modulation types supported, sub-carrier spacing supported, or the like.

At block 612, the network entity relays data between the first instance of the application and an application server based on the first set of capabilities. The network entity relays user-plane data between the first UE and the application server using the common virtual-UE-set session context of the virtual UE set. Additionally or optionally, the network entity updates the virtual-UE-set session context to produce a current virtual-UE-set context. For example, the network entity updates the virtual-UE-set session context based on the instantiation of the first instance of the application.

At block 614, the network entity determines that that the application focus has switched from the first UE to a second UE. For example, a user stops playing a first instance of a game application on a smart-TV and continues to play the game application using a second instance of the game application on a smartphone. Alternatively, the application may be in-focus for the second UE concurrently with the first UE.

At block 616, the network entity applies a second set of capabilities associated with the second UE to the session for the application. For example, based on the capabilities of the second UE, the network entity adjusts network parameters to match the capabilities of the second UE, such as a maximum downlink throughput, maximum uplink throughput, MIMO layers, a number of carriers that can be aggregated, a maximum bandwidth supported, modulation types supported, sub-carrier spacing supported, or the like. In the alternative of two UEs concurrently being in-focus for the application, the network entity applies a second set of capabilities that represents the lowest common denominator for capabilities that are available from both the first UE and the second UE.

At block 618 the network entity relays data between the second instance of the application and an application server based on the second set of capabilities. The network entity relays user-plane data between the second UE and the application server using the common virtual-UE-set session context of the virtual UE set. In the alternative of two UEs concurrently being in-focus for the application, the network entity relays data between both UEs and the application server using the second set of least common denominator capabilities.

The order in which the method blocks of method 600 are described are not intended to be construed as a limitation, and any number of the described method blocks can be skipped or combined in any order to implement a method or an alternate method. Generally, any of the components, modules, methods, and operations described herein can be implemented using software, firmware, hardware (e.g., fixed logic circuitry), or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

In the following text some examples are described:
Example 1: A method for managing a virtual user equipment, UE, set by a network entity, the method comprising the network entity:
   registering multiple user equipment to the virtual UE set;
   generating a virtual-UE-set session context;
   sending a virtual-UE-set context notification to a base station, directing the base station to transmit the virtual-UE-set session context to each of the multiple user equipment in the virtual UE set;
   determining that a first user equipment in the virtual UE set is in-focus for a first instance of an application;
   applying a first set of capabilities associated with the first UE to a session for the first instance of the application;
   relaying data between the first instance of the application and an application server based on the first set of capabilities; and
   based on the relaying, updating the virtual-UE-set session context to produce a current virtual-UE-set context.
Example 2: The method of example 1, wherein the registering the multiple user equipment to the virtual UE set comprises:
   receiving a virtual-UE-set registration request message from each of the multiple UEs; authorizing each of the multiple UEs;
   determining a common security context for the multiple UEs in the virtual UE set; and
   transmitting a virtual-UE-set registration accept message to each of the multiple UEs.
Example 3: The method of example 2, wherein transmitting the virtual-UE-set registration accept message to each of the multiple UEs comprises:
   transmitting the common security context to each of the multiple UEs.
Example 4: The method of example 3, wherein the multiple UEs registered to the virtual UE set share a common security key.
Example 5: The method of example 4, wherein the common security key is a virtual-UE-set master key.
Example 6: The method of example 1, further comprising:
   assigning a common Globally Unique Temporary Identifier, GUTI, to the multiple user equipments registered to the virtual UE set.
Example 7: The method of example 1, wherein the generating the virtual-UE-set context comprises the network entity:
   generating a set of session context information that includes session context information previously exchanged between one or more of the multiple user equipment in the virtual UE set and the network entity.
Example 8: The method of example 1, further comprising the network entity:
   determining a second user equipment in the virtual UE set is in-focus for a second instance of the application;
   applying either the first set of capabilities associated with the first UE or a second set of capabilities associated with the second UE to the session for the second instance of the application; and
   sending the current virtual-UE-set context to the second user equipment.
Example 9: The method of example 8, wherein applying either the first set of capabilities associated with the first UE or the second set of capabilities associated with the second UE to the session for the second instance of the application comprises:
   determining that the second set of capabilities is different from the first set of capabilities; based on the determining, applying the second set of capabilities to the session for the second instance of the application; and
   relaying data between the second instance of the application and the application server based on the second set of capabilities.
Example 10: The method of example 9, wherein the relaying the data to the second instance of the application comprises:
   relaying the data to the first instance of the application on the first UE and the second instance of the application on the second UE using a shared allocation of air interface resources.
Example 11: The method of example 1, further comprising the network entity:
   determining a second user equipment in the virtual UE set is in-focus for a second instance of the application;
   based on the determining, applying a second set of capabilities associated with the second UE to the session for the second instance of the application; and
   relaying data between the second instance of the application and the application server based on the second set of capabilities.
Example 12: The method of example 11, further comprising the network entity:
   determining that the first user equipment in the virtual UE set is defocused for the application.
Example 13: The method of any one of the preceding examples, wherein the virtual-UE-set context notification includes a common Cell Radio Network Temporary Identifier, C-RNTI, for the multiple user equipment registered to the virtual UE set, and wherein sending the virtual-UE-set context notification to the base station, directs the base station to communicate with the multiple UEs in the virtual UE set using the common C-RNTI.
Example 14: The method of any one of the preceding examples, wherein the virtual-UE-set session context includes an Internet Protocol, IP, address that is common to all UEs registered to the virtual UE set; and wherein relaying data between an application instance and the application server comprises:
   relaying the data using the common IP address.
Example 15: The method of any one of the preceding examples, wherein the virtual-UE-set session context includes a Protocol Data Unit, PDU, session that is common to all UEs registered to the virtual UE set; and wherein relaying data between an application instance and the application server comprises:
   relaying the data using the common PDU session.
Example 16: The method of any one of the preceding examples, wherein the virtual-UE-set session context includes a Quality of Service, QoS, flow that is common to all UEs registered to the virtual UE set; and wherein relaying data between an application instance and the application server comprises:
   relaying the data using the common QoS flow.
Example 17: The method of any one of the preceding examples, wherein the virtual-UE-set session context includes a network slice that is common to all UEs registered to the virtual UE set; and wherein relaying data between an application instance and the application server comprises:
   relaying the data using the common network slice.
Example 18: A network entity comprising:
   a core network interface;
   a processor; and
   instructions for a core network application that are executable by the processor to configure the network entity to perform any one of methods 1 to 17.

Although aspects of a virtual user equipment set have been described in language specific to features and/or methods, the subject of the appended claims is not necessarily limited to the specific features or methods described. Rather, the specific features and methods are disclosed as example implementations of a virtual user equipment set, and other equivalent features and methods are intended to be within the scope of the appended claims. Further, various different aspects are described, and it is to be appreciated that each described aspect can be implemented independently or in connection with one or more other described aspects.

1-14. (canceled)

15. A method for managing a virtual user equipment (UE) set by a network entity, the method comprising the network entity:
registering multiple user equipment to the virtual UE set;
generating a virtual-UE-set session context;
sending a virtual-UE-set context notification to a base station, directing the base station to transmit the virtual-UE-set session context to each of the multiple user equipment in the virtual UE set;
determining that a first user equipment in the virtual UE set is in-focus for a first instance of an application, the first user equipment in the virtual UE set being in-focus for the first instance of the application when a user is actively engaging with the first instance of the application via the first user equipment;
applying a first set of capabilities associated with the first UE to a session for the first instance of application;
relaying data between the first instance of the application and an application server based on the first set of capabilities; and
based on the relaying, updating the virtual-UE-set session context to produce a current virtual-UE-set context.

16. The method of claim 15, wherein the registering the multiple user equipment to the virtual UE set comprises:
receiving a virtual-UE-set registration request message from each of the multiple UEs;
authorizing each of the multiple UEs;
determining a common security context for the multiple UEs in the virtual UE set; and
transmitting a virtual-UE-set registration accept message to each of the multiple UEs.

17. The method of claim 16, wherein transmitting the virtual-UE-set registration accept message to each of the multiple UEs comprises:
transmitting the common security context to each of the multiple UEs.

18. The method of claim 17, wherein the multiple UEs registered to the virtual UE set share a common security key.

19. The method of claim 18, wherein the common security key is a virtual-UE-set master key.

20. The method of claim 15, further comprising:
assigning a common Globally Unique Temporary Identifier (GUTI) to the multiple user equipments registered to the virtual UE set.

21. The method of claim 15, wherein the generating the virtual-UE-set context comprises the network entity:
generating a set of session context information that includes session context information previously exchanged between one or more of the multiple user equipment in the virtual UE set and the network entity.

22. The method of claim 15, wherein applying either the first set of capabilities associated with the first UE or a second set of capabilities associated with the second UE to the session for a second instance of the application comprises:
determining that the second set of capabilities is different from the first set of capabilities;
based on the determining, applying the second set of capabilities to the session for the second instance of the application; and
relaying data between the second instance of the application and the application server based on the second set of capabilities.

23. The method of claim 22, wherein the relaying the data to the second instance of the application comprises:
relaying the data to the first instance of the application on the first UE and the second instance of the application on the second UE using a shared allocation of air interface resources.

24. The method of claim 15, further comprising the network entity:
determining a second user equipment in the virtual UE set is in-focus for a second instance of the application, the second user equipment in the virtual UE set being in-focus for the second instance of the application when a user is actively engaging with the second instance of the application via the second user equipment;
based on the determining, applying a second set of capabilities associated with the second UE to the session for the second instance of the application; and
relaying data between the second instance of the application and the application server based on the second set of capabilities.

25. The method of claim 24, further comprising the network entity:
determining that the first user equipment in the virtual UE set is defocused for the application, the first user equipment in the virtual UE set being defocused for the application when a user is not actively engaging with the application via the first user equipment.

26. The method of claim 15, wherein the virtual-UE-set context notification includes a common Cell Radio Network Temporary Identifier (C-RNTI) for the multiple user equipment registered to the virtual UE set, and wherein sending the virtual-UE-set context notification to the base station, directs the base station to communicate with the multiple UEs in the virtual UE set using the common C-RNTI.

27. A network entity comprising:
a core network interface;
a processor; and
instructions for a core network application that are executable by the processor to configure the network entity to:
register multiple user equipment (UE) to the virtual UE set;
generate a virtual-UE-set session context;
send a virtual-UE-set context notification to a base station, that directs the base station to transmit the virtual-UE-set session context to each of the multiple user equipment in the virtual UE set;
determine that a first user equipment in the virtual UE set is in-focus for a first instance of an application, the first user equipment in the virtual UE set being in-focus for the first instance of the application when a user is actively engaging with the first instance of the application via the first user equipment;
apply a first set of capabilities associated with the first UE to a session for the first instance of the application;
relay data between the first instance of the application and an application server based on the first set of capabilities; and
based on the relay of the data, update the virtual-UE-set session context to produce a current virtual-UE-set context.

28. The method of claim 15, further comprising the network entity:
determining a second user equipment in the virtual UE set is in-focus for a second instance of the application, the second user equipment in the virtual UE set being in-focus for the second instance of the application when a user is actively engaging with the second instance of the application via the second user equipment;
applying either the first set of capabilities associated with the first UE or a second set of capabilities associated with the second UE to the session for the second instance of the application; and
sending the current virtual-UE-set context to the second user equipment.

29. The network entity of claim 27, wherein the instructions to register the multiple user equipment to the virtual UE set are further executable to configure the network entity to:
receive a virtual-UE-set registration request message from each of the multiple UEs;
authorize each of the multiple UEs;
determine a common security context for the multiple UEs in the virtual UE set; and
transmit a virtual-UE-set registration accept message to each of the multiple UEs.

30. The network entity of claim 29, wherein the instructions to transmit the virtual-UE-set registration accept message to each of the multiple UEs are further executable to configure the network entity to:
transmit the common security context to each of the multiple UEs.

31. The network entity of claim 30, wherein the multiple UEs registered to the virtual UE set share a common security key.

32. The network entity of claim 31, wherein the common security key is a virtual-UE-set master key.

33. The network entity of claim 27, wherein the instructions are further executable to configure the network entity to:
assign a common Globally Unique Temporary Identifier (GUTI) to the multiple user equipments registered to the virtual UE set.

34. The network entity of claim 27, wherein the instructions to generate the virtual-UE-set context are further executable to configure the network entity to:
generate a set of session context information that includes session context information previously exchanged between one or more of the multiple user equipment in the virtual UE set and the network entity.
